(19) United States
(12) Patent Application Publication
(10) Pub. No.: US 2008/0094821 A1
(43) Pub. Date: Apr. 24, 2008

(54) RISING WATERFALL UNIT

(76) Inventor: Zachary Vogtner, Atlanta, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/552,237

(22) Filed: Oct. 24, 2006

(51) Int. Cl. F21V 33/00

(52) U.S. Cl. 362/101

(57) ABSTRACT

A rising water feature that produces a waterfall into a spa, swimming pool, tub, reservoir, or the like, while the device itself is illuminated. In a resting position, the device is retracted and has a generally flat profile relative to the spa surface. In an operation position, the device is extended above the spa surface.

### BACKGROUND OF THE INVENTION

1. Technical Field

The present invention generally is in the field of water features for use in connection with artificial bodies of water, and more particularly is in the field of devices for generating aesthetically pleasing waterfalls in spas, swimming pools, tubs, hydrotherapy equipment, and the like.

2. Related Art

Few applications derive more benefit from the addition of waterfalls, fountains and other water features than artificial bodies of water such as spas, swimming pools, tubs, and other such structures. The popularity of waterfalls, fountains and other water features in such structures is probably associated with the numerous aesthetic and practical applications that make water features desirable. More specifically, the addition of a water feature to an artificial body of water can provide a substantial decorative effect or can provide a relaxing background sound, generated from the water flow. As such, users and owners of artificial bodies of water often desire the addition of water features.

Various water features are known and available. For example, water features produce a relatively thin and round jet of water that can arc into the body of water. For another example, waterfalls produce a relatively broad sheet of water that can fall into the body of water. For another example, watersprays produce a relatively broad and widespread spray of water into a body of water. Each of these common know devices have structures that can be considered static in that the devices are securely and permanently attached to the side or edge of the body of water, and merely discharge water when in operation. Few if any of these common known devices are dynamic in that, for example, they do not have moving part, they do not extend out of the wall of the body of water when in use and/or retract into the wall of the body of water when not in use.

Various illuminated water features also are known. For example, there are waterfalls and waterjets that have an integrated light so as to color the water being discharged from the waterfall or waterjet. Few if any of these common known devices are fully illuminated in that, for example, they are not structured such that the light also illuminates the material of construction so as to create a combined illuminated water stream emanating from an illuminated water feature structure.

Accordingly, there is a need for a device that allows for the addition of a water feature to an artificial body of water, such as a spa, swimming pool, tub or the like that automatically can extend when in use and retract when not in use, both for safety and aesthetical reasons. There is also a need for such a device to be able to produce an illuminated discharge of water for enhanced aesthetics. There is a further need for such a device to be able to have a structure that also is illuminated for even more enhanced aesthetics. It is to these needs and others that the present invention is directed.

### BRIEF SUMMARY OF THE INVENTION

Briefly described, the present invention is a water feature that produces a generally umbrella- or mushroom-shaped waterfall into a spa, swimming pool, tub, reservoir, or the like, while the device itself is illuminated. The device also provides a means for filling such a reservoir with water. For simplicity in this disclosure, spas, swimming pools, birdbaths, ponds, tubs, hydrotherapy equipment, and the like, and all such reservoirs and artificial bodies of water, together or separately will be referred to as “spas” or a “spa”. Further, the term “mushroom-shaped” is meant to include all geometric shapes including the typical round (when viewed from above), but also including but not limited to ovals, triangles, squares, other regular and irregular polygons, and ornamental shapes of all kinds.

The invention generally is a device that can be installed on a surface of a spa to provide for the addition of an aesthetically pleasing and decorative waterfall that flows into a spa. In the invention, water from a water source flows into the water feature and then passes up through and out of the water feature to form a water stream that lands in the spa or on an edge of the spa. An illumination source illuminates the water feature structure and the water flowing inside of the water feature structure. Because the device is preferably placed above the surface of the water in the spa, the waterfall can be a smooth flow of water falling from the water feature in a generally mushroom-shaped pattern until it falls onto the edge of the spa or onto the surface of the water in the spa.

The water feature structure of the present invention generally comprises a water inlet, at least partially transparent or translucent tubes and/or conduits, and an illumination source. It is preferred that the illumination source, transparent tubing, nozzle and outlet are situated axially, with preferably a substantially vertical axis, relative to each other to maximize transference of the light to the water stream within the water feature structure so as to provide illumination to the water feature structure. The water feature can be anchored to a horizontal surface of a spa, or to a surface proximal to a spa, using any appropriate means as long as water can be fed into, and water can flow out of, the water feature. In a preferred embodiment, the device can be installed with a minimum of disturbance to the surrounding spa with only a single round hole that may be made with a standard power drill as opposed to typical fountain devices that may require complex cuts and accompanying high costs of installation. The present invention therefore also can be much less costly to install than other mounted waterfall fountain devices.

The water feature structure of the present invention comprises concentric and coaxial tubes, the outer tube being anchored to the spa and the inner tube being able to slide upwardly and downwardly within the outer tube, with the axes of both the outer tube and the inner tube being substantially vertical. When the device is off, namely when water is not flowing through the device, the inner tube slides by gravity downwardly into the outer tube into a resting position with the top of the inner tube generally coplanar or nearly coplanar with the top of the outer tube. A top surface, flange or other stop prevents the inner tube from falling completely within the outer tube. When the device is on, namely when water is flowing through the device, the inner tube is forced by the flowing water pressure upwardly, but not completely, out of the outer tube into an operating position with the top of the inner tube and at least a portion of the inner tube extending out of the outer tube. A flange or other stop prevents the inner tube from falling or completely extending out of the outer tube.

In use, water flows from the water source into the device, specifically into the outer tube. Baffles located on the inner tube, preferably on the bottom water inlet opening of the inner tube but also or alternatively within the hollow interior of the inner tube, create water pressure such that water following from the outer tube into the inner tube forces the inner tube upwardly out of the outer tube until the flange or other stop halts any further upward extension and prevents the inner tube from completely extending out of the outer tube. At this extension, the inner tube, and specifically the top of the inner tube where the water outlet opening is located, is located a certain distance above the outer tube and thus a certain distance above the spa. After the inner tube has risen to its highest extension, and also possibly while the inner tube is rising, water flows upwardly through the inner tube and out of the water outlet, falling over a shaped top so as to create a generally mushroom-shaped waterfall back into the spa. The shaped top has a water outlet located therethrough, allowing the water to flow out from the interior of the inner tube, at which point gravity forces the water to flow downward over and about the shaped top, thus creating the water fall.

A light source is located axially below the inner tube and the outer tube so as to be able to shine upwardly through the inner tube and the outer tube. When the inner tube is extended and water is flowing through the inner tube, the inner tube is visible to the spa user, and the light illuminates the water and the inner tube, thus creating an aesthetically pleasing lighted water feature. The light can be turned on and off as desired so as to allow the user to have an illuminated or non-illuminated water feature, as desired.

The device can be used on almost any artificial water body. While the device is described in connection with a spa, it is understood that the device can be used on spas, swimming pools, tubs, and the like. For example, the device can be placed on the edge of a swimming pool so as to provide a fountain or an illuminated fountain into the swimming pool. One of ordinary skill in the art can modify the device without undue experimentation so that it can be placed on almost any artificial water body.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

The invention may be more completely understood in consideration of the following detailed description of various embodiments of the invention in connection with the accompanying drawings, in which:

FIG. 1 is a side view, partly in section, of a spa unit with an embodiment of the waterfall device of the present invention mounted to the upper ledge of the spa unit and located near, or slightly above, the waterline of the spa unit, and in the retracted or resting position.

FIG. 2 is a side view, partly in section, of a spa unit depicted in FIG. 1 showing the waterfall device in the operating or extended position.

FIG. 3 is more detailed side view, partly in section, of a spa unit depicted in FIG. 1 showing the waterfall device in the operating or extended position.

FIG. 4A is an expanded view of the inner tube of the waterfall device highlighting the bottom surface and a first embodiment of baffles thereon.

FIG. 4B is an expanded view of the inner tube of the waterfall device highlighting the bottom surface and a second embodiment of baffles thereon and with an alternative top surface shape.

FIG. 4C is an expanded view of the inner tube of the waterfall device highlighting the bottom surface and a third embodiment of baffles thereon and with an alternative top surface shape.

FIG. 5 is a side cross-section of an embodiment of the present invention in the retracted or resting position.

FIG. 6 is a side cross-section of an embodiment of the present invention in the extended or operating position.

FIG. 7 is a cross sectional view of an embodiment of the present invention depicting an optical illumination approach.

### DETAILED DESCRIPTION OF PREFERRED EMBODIMENTS

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

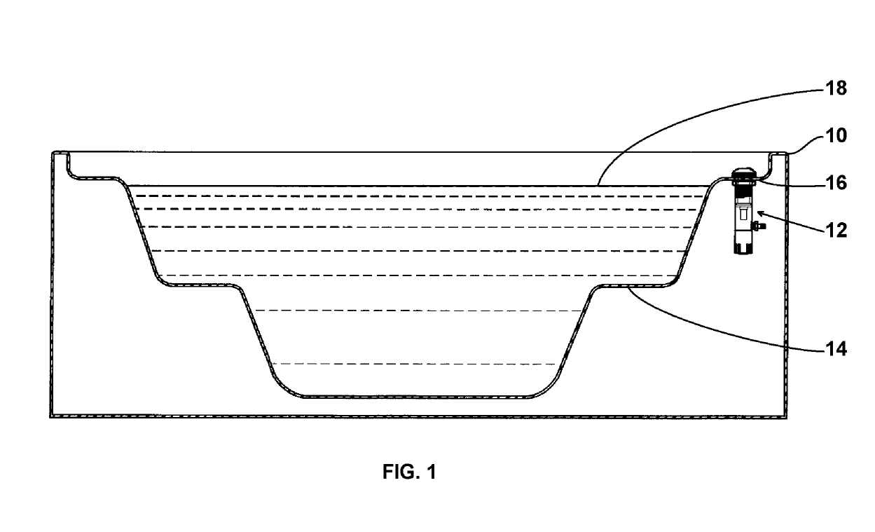

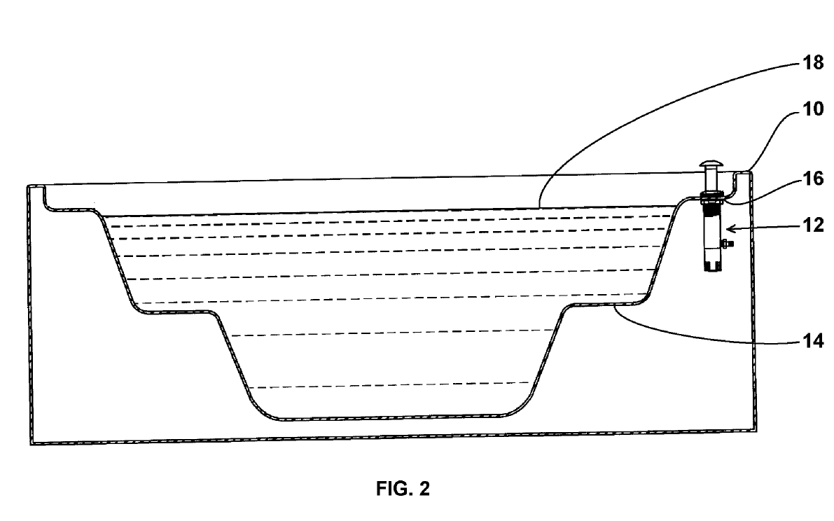

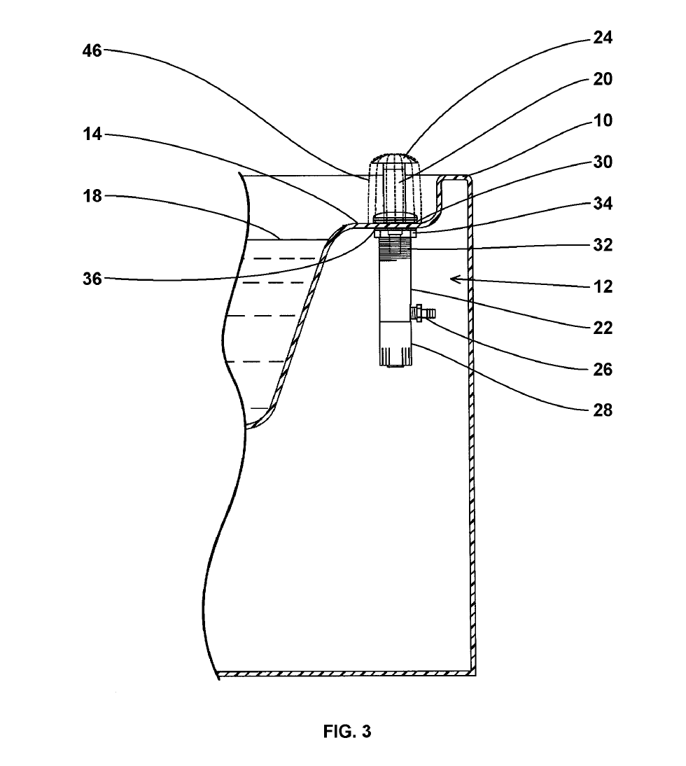

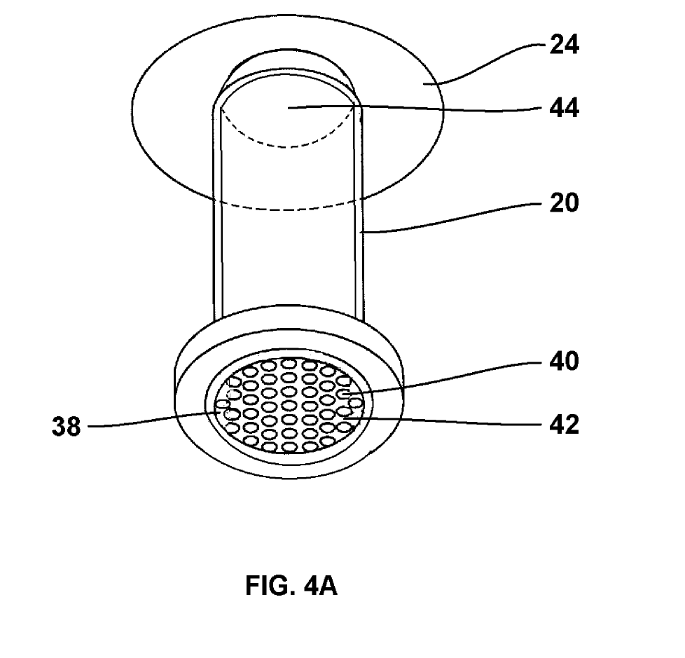

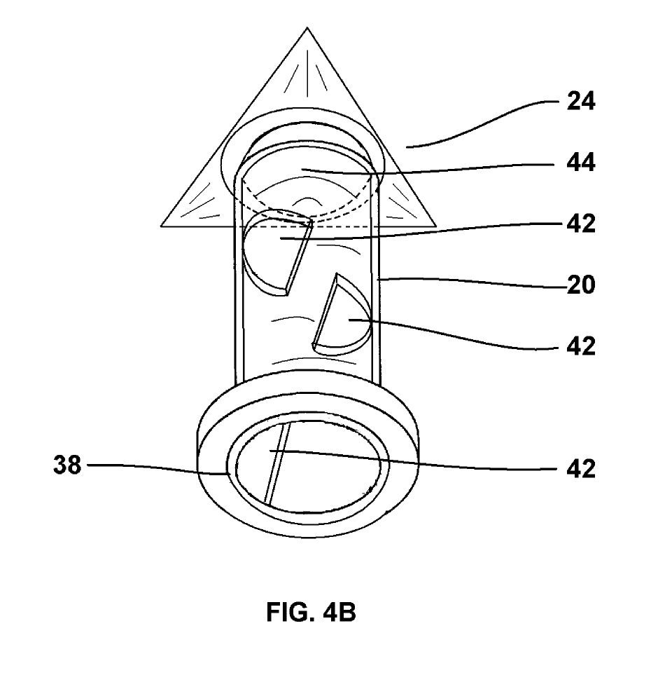

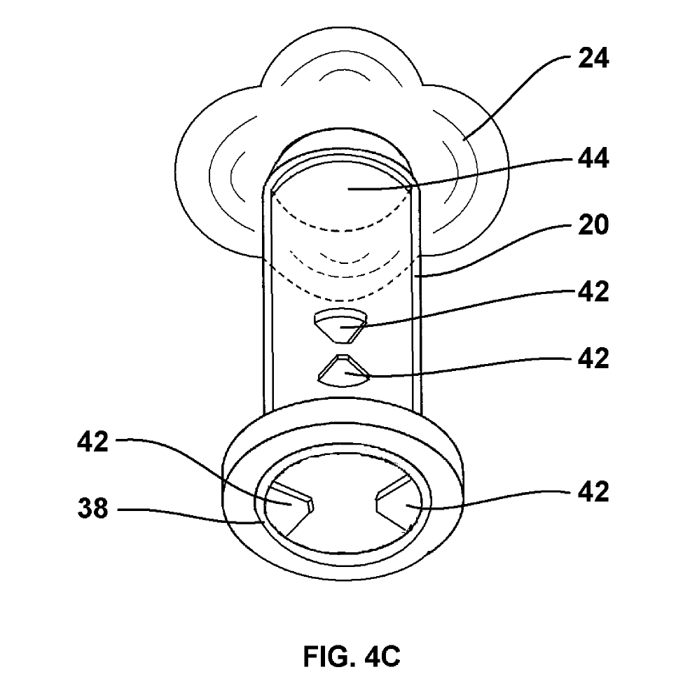

FIG. 1 is a side view, partly in section, of a spa unit with an embodiment of the waterfall device of the present invention mounted in an illustrative position on the upper ledge of the spa unit and located near, or slightly above, the waterline of the spa unit, and in the retracted or resting position. FIG. 2 is the same view as FIG. 1 showing the waterfall device in the operating or extended position. FIG. 3 is more detailed side view, partly in section, of a spa unit depicted in FIG. 1 showing the waterfall device in the operating or extended position with water flowing through the unit and generating a mushroom-shaped waterfall. FIG. 4 is an expanded view of the inner tube of the waterfall device highlighting the bottom surface, several embodiments of the water pressure-creating baffles, and several embodiments of the shape of the top surface.

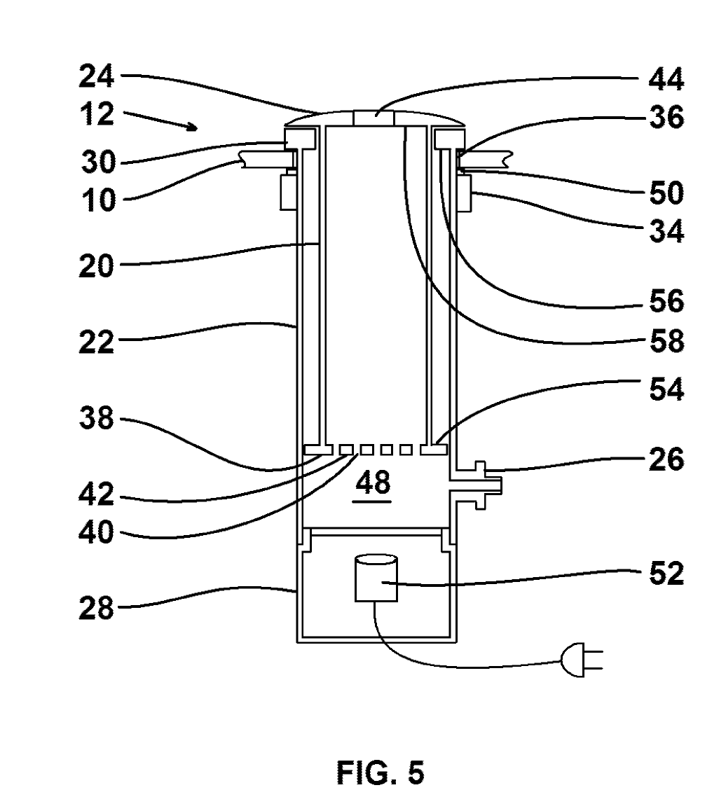

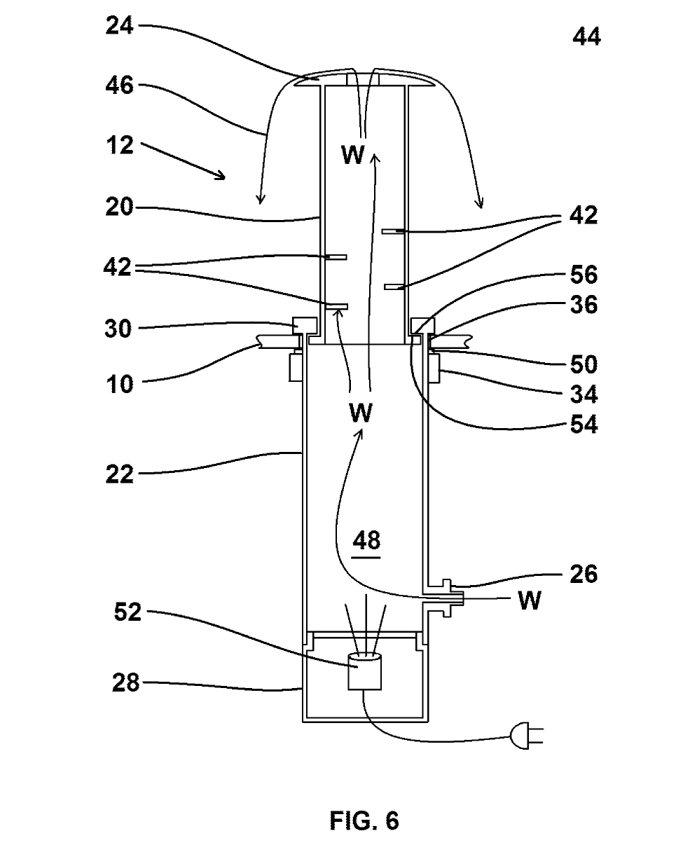

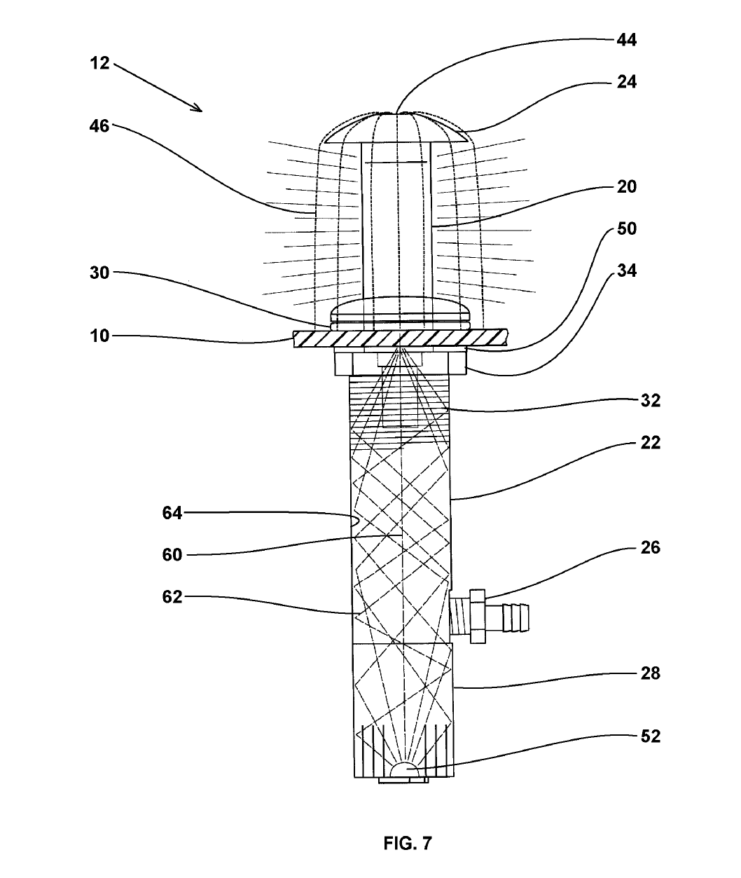

FIG. 5 is a side cross-section of an embodiment of the present invention in the retracted or resting position illustrating the structural relationship of the various components of the device. FIG. 6 is the same view as FIG. 5 in the extended or operating position. FIG. 7 is a cross sectional view of an embodiment of the present invention depicting an optical illumination approach showing how the light can shine through the water, the outer tube and the inner tube.

Referring now to FIGS. 1 and 2, one Illustrative embodiment of a spa unit 10 with an integrated rising lighted waterfall device 12 according to the present invention is shown. The spa unit 10 shown is used herein for illustrative purposes only and can have a pair of ledges 14 and 16, wherein the waterfall device 12 can be securely mounted to the upper ledge 14 with the top surface of the waterfall device 12 near, or slightly above, the waterline 18 of the spa unit 10. There may be a series of similar waterfall devices 12 spaced around the circumference of the spa unit 10 at regular intervals on upper ledge 14. FIG. 1 illustrates the waterfall device 12 in the retracted or resting position and FIG. 2 illustrates the waterfall device 12 in the extended or operating position.

Referring now to FIG. 3, the waterfall device 12 is shown in somewhat greater detail. Waterfall device 12 minimally comprises inner tube 20, outer tube 22, and top surface 24. Water inlet 26 connects to a water source (not shown) for supplying water to the waterfall device 12. Light compartment 28 attached to or is an extension of the bottom of outer tube 22. Outer tube 22 is a generally cylindrical structure having a hollow interior, a means for connecting light compartment 28 to the bottom, a flange or shoulder 30 about the top for supporting the outer tube 22 on the spa unit 10, and a threaded outer surface 32 for cooperating with a nut 34 for mounting the outer tube 22 on the spa unit 10. Inner tube 20 also is a generally cylindrical structure having a hollow interior, with top surface 24 corresponding to the top of inner tube 20. Both inner tube 20 and outer tube 22 will be disclosed in more detail below.

As can be seen in FIG. 3, the waterfall device 12 is mounted on the spa unit 10 by sliding the waterfall device 12 through a mounting hole 36 having approximately the same diameter as the outer diameter of the outer tube 22. Once the flange or shoulder 30 is resting on the top surface of the spa unit 10, the nut 34 is slid over the outer tube 22 from below and screwed onto threaded outer surface 32 until the nut 34 is tight against the bottom surface of the spa unit 10, thus securing the waterfall device 12 onto the spa unit 10. A water source (not shown) then can be attached to the water inlet 26.

Referring now to FIGS. 4A, 4B and 4C, an expanded view of the inner tube 20 inside a cutaway portion of the outer tube 22 is shown, highlighting a view of several illustrative embodiments of the baffles 42 and a view of several shapes for top surface 24. The inner tube 20 has at least one baffle 42 on or proximal to the bottom surface 38 of the inner tube 20 or within the hollow interior of the inner tube 20. Water entering the hollow interior of outer tube 22 will eventually impinge upon the baffles 42 applying the necessary driving force to initiate the inner tube 20 to elevate vertically by sliding upwardly in outer tube 22. As such, inner tube 20 must have an outer diameter less than, and preferably only slightly less than, the inner diameter of outer tube 22. Generally, the outer diameter of the outer tube 22 is on the order of about 1 inch to about 4 inches, with about 2 inches to about 3 inches preferred. The height of inner tube 20, and thus the height of extension of the waterfall device 12 above the spa unit 10 surface when operating, is on the order of about 2 inches to about 12 inches, with about 4 inches to about 7 inches preferred.

Referring now to FIG. 4A, a first expanded view of the inner tube is shown, highlighting a view of the bottom surface 38 thereof. The bottom surface 38 of the inner tube 20 can have a series of openings 40 forming a first illustrative embodiment of baffle 42 on the bottom surface 38. Water entering the hollow interior of outer tube 22 will eventually impinge upon bottom surface 38 applying the necessary driving force to initiate the inner tube 20 to elevate vertically by sliding upwardly in outer tube 22. Thus, inner tube 20 is slidably displaceable within outer tube 22. Water also travels through openings 40 into inner tube 20 and then eventually will exit inner tube 20 through water outlet 44 and then fall over top surface 24 to create the waterfall 46. This figure illustrates a generally round top surface 24, resulting in a common mushroom-shaped waterfall 46.

Referring now to FIG. 4B, a second expanded view of the inner tube 20 is shown, highlighting a view of the inner surface thereof. The inner surface of the inner tube 20 can have a series of plates or steps forming a second illustrative embodiment of baffle 42. Water entering the hollow interior of outer tube 22 will eventually enter the hollow interior of inner tube 20 and impinge upon baffles 42 applying the necessary driving force to initiate the inner tube 20 to elevate vertically by sliding upwardly in outer tube 22. Water then eventually will exit inner tube 20 through water outlet 44 and then fall over top surface 24 to create the waterfall 46. This figure illustrates a triangular top surface 24, resulting in a more triangular-shaped waterfall 46.

Referring now to FIG. 4C, a third expanded view of the inner tube 20, highlighting a view of the inner surface thereof. The inner surface of the inner tube 20 can have a series of fingers forming a third illustrative embodiment of baffle 42. Water entering the hollow interior of outer tube 22 will eventually enter the hollow interior of inner tube 20 and impinge upon baffles 42 applying the necessary driving force to initiate the inner tube 20 to elevate vertically by sliding upwardly in outer tube 22. Water then eventually will exit inner tube 20 through water outlet 44 and then fall over top surface 24 to create the waterfall 46. This figure illustrates a clover-shaped top surface 24, resulting in a more complex clover-shaped waterfall 46.

Other structures for baffles 42, both known and future developed, and equivalents, are suitable for use in the present invention. Additionally, other shapes for top surface 24 are suitable for use in the present invention to result in different shaped waterfalls 46. Further, it is contemplated that the inner tube 20 or the top surface 24 can be made interchangeable, such that different inner tubes 20 including a top surface 24, or different top surfaces 24, can be used with a single installed outer tube 22 such that the shape of the waterfall 46 can be changed by the spa unit 10 user as desired.

Referring now to FIGS. 5 and 6, cross-sections of the present invention are shown to highlight the components of the invention and the operating relationships of the components relative to each other. FIG. 5 illustrates the device in the retracted or resting position (off) and with the baffles 42 shown in FIG. 4A, and FIG. 6 illustrates the device in the extended or operating (on) position and with the baffles 42 shown in FIG. 4B. Further, the combination of FIGS. 5 and 6 show the preferred operation of the waterfall device 12.

Referring now to FIG. 5, in the retracted position, inner tube 20 is substantially within outer tube 22, with top surface 24 resting on or proximal to the top edge of outer tube 22. The bottom surface 38 of inner tube 20 preferably is located above the water inlet 26 so as to create a manifold space 48. Outer tube 22 is mounted on the spa unit 10 via mounting hole 36, whereby flange or shoulder 30 rests on the top surface of the spa unit 10 and nut 34 cooperating with threaded outer surface 32 (see FIG. 3) holds outer tube 22 in place. A washer 50 can be used to effect a better mounting. Light compartment 28 is attached to the bottom of outer tube 22 by common means such as for example friction, threaded and/or clip couplings. An illumination source 52 is located in light compartment 28 and is disclosed in more detail in connection with FIG. 7. Illumination source 52 is shown as off.

Referring now to FIG. 6, in the extended position, inner tube 20 is substantially outside of outer tube 22, with top surface 24 elevated above the top edge of outer tube 22. Inner tube 20 comprises stop tab 54 that cooperates with stop flange 56 on outer tube 22 so as to halt the upward progress of inner tube 20 and to prevent inner tube 20 from being forced out of outer tube 22. Stop tab 54 can be at least one protrusion, a radial ring, or the like extending outwardly horizontally from the bottom edge of inner tube 20, and many different suitable structures can be designed by those of skill in the art. Stop flange 56 can be at least one protrusion, a radial ring, or the like extending inwardly horizontally from the top edge of outer tube 22, and many different suitable structures can be designed by those of skill in the art. It is important that stop tab 54 and stop flange 56, of whatever suitable structure, cooperate with each other to prevent inner tube 22 from being forced out of outer tube 22 by the water pressure. Illumination source 52 is shown as on.

Water W enters outer tube 22 via water inlet 26 and, if present, fills manifold space 48. As water W continues to fill outer tuber 22, water W also impinges upon baffles 42, whether on the bottom surface 38 as shown in FIG. 5 or in the hollow interior of inner tube 20 as shown in FIG. 6, creating the upward pressure to cause inner tube 20 to rise within outer tube 22. Further, as water W fills the hollow interior of inner tube 20, water W will contact the top wall 58 of inner tube 20, creating additional upward pressure on inner tube 20.

Inner tube 20 is sized and structured to slide upwardly and downwardly within outer tube 22 until stop tab 54 abuts against stop flange 56. With sufficient water pressure entering water inlet 26 to drive inner tube 20 vertically, water W also may begin passing through openings 40 (FIGS. 4A and 5) and fill the hollow interior of inner tube 20. With a continuation of water W entering through water inlet 26 with sufficient water pressure to hold the inner tube 20 in its extended position, eventually inner tube 20 will completely fill with water W, and water W may begin exiting the top surface 24 through water outlet 44. The top surface 24 may be a curved surface as shown in the FIGs., and water W exiting water outlet 44 may flow smoothly along top surface 24 eventually falling off the edge thereof, thereby forming a waterfall 46.

FIGS. 5 and 6 also illustrate a preferred method for mounting waterfall device 12 on a spa unit 10. The waterfall device 12, or just the outer tube 22, is inserted into a mounting hole 36 formed into spa unit 10. The mounting hole 36 formed into spa unit 10 should be of a size and shape so as to cooperate with the size and shape of outer tube 22. Once the waterfall device 12, or just the outer tube 22, is inserted into the mounting hole 36 such that the flange or shoulder 30 rests against spa unit 10 upper surface, mounting nut 34 is screwed onto threaded outer surface 32 and tightened against spa unit 10 lower surface, thus securing the waterfall device 12 onto the spa unit 10.

Illumination source 52 provides the light source for illuminating waterfall device 12 and is attached to the outer tube 22 by any suitable known means. As disclosed in more detail below, it is preferred that illumination source 52 be at least one light emitting diode (“LED”) or similar high intensity, shock-resistant, water-resistant light sources. When light compartment 28 is attached to outer tube 22, light from illumination source 52 is directed through transparent or translucent portions of the outer tube 22, namely a translucent or transparent base of outer tube 22, and into water W stream that is traveling through the waterfall device 12. As such, the light will illuminate the water W and/or the extended inner tube 20, and preferably the water W exiting the waterfall device 12 as the waterfall 46, to create an aesthetically pleasing illuminated water feature.

It is preferred that at least some portion of, and preferably all of, inner tube 20 and top surface 24, is transparent or translucent to allow light emanating from illumination source 52 to illuminate waterfall device 12 and to be transmitted to the water W stream within and exiting the waterfall device 12. It is more preferred that the walls of all internal conduits and chambers be of transparent material to allow as much transmission of light into the water stream as possible. Several preferred materials for such construction are Plexiglas®, Xylex™, and transparent or translucent plastics, ceramics, minerals, glasses and the like. Further, internal surfaces of the outer tube 22 can be covered in a mirrored material to further enhance light transference to the inner tube 20 and the water W stream.

With reference to FIG. 7, the waterfall device 12 also may be configured to illuminate the waterfall 46 flowing from the top surface 24 of the inner tube 20 in the extended position. The illumination source 52 may be light emitting diodes (LED's), laser diodes, tungsten halogen lamps with colored filters, high intensity xenon lamps, or similar such devices known to those skilled in the art of optical illumination. In one embodiment of the present invention the illumination source 52 may be a colored LED oriented such that its output radiation 60 propagates generally in the vertical direction. Additional radiation 62 from the LED may propagate in a direction to reflect multiple times off the wall 64 en route to inner tube 20. A portion of the light propagating through water filled outer tube 22 may be scattered in all directions via the interaction with water molecules, with the non-scattered and reflected light propagating into inner tube 20. The light entering inner tube 20 may in turn be scattered in all directions by water molecules and cause inner tube 20 to be colored. The scattered light from within the inner tube 20 may in turn pass through the waterfall 46 giving it, in this embodiment a colored tint.

In an alternative embodiment, the illumination source 52 may consist of multiple light sources in close proximity. For example, the illumination source 52 may consist of a combination of red, green, and blue light emitting diodes and the individual LED's may be electronically timed to illuminate one at a time giving the pleasant appearance of a changing color waterfall.

In another alternative embodiment of the present invention, the outer tube 22 may be segregated into two concentric cavities to increase the efficiency in illuminating the water in inner tube 20. In this embodiment, light emanating from illumination light source 52 can propagate through the outer tube 22 without the loss of energy via scattering by water molecules as explained before, and thereby more efficiently transferring light energy to the inner tube 20 to ultimately illuminate the waterfall 46. In this embodiment, the illumination source 52 may have an optical lens or equivalent focusing type device to preferentially direct light into inner tube 20.

Preferably, connections between the source water conduit (not shown) and water inlet 26 as well as all other joints are as watertight as possible. If the connections between the various components of waterfall device 12 are not watertight, water may escape though the connections. In some cases, it may be optimal to use fillers, sealants, o-rings or the equivalent to help ensure watertight connection between the parts of waterfall device 12, particularly as it relates to water inlet 26 and the mounting of the waterfall device 12 onto the sap unit 10 and the various conduits and/or chambers. Methods for ensuring a watertight connection between parts or plumbing parts are known by one of ordinary skill in the art.

Waterfall device 12 can be manufactured from relatively inexpensive materials. For example, the components of waterfall device 10 can be formed of plastics, ceramics, metal, or other materials. Preferably, the components of waterfall device 12 can be molded or formed from a plastic material that will not corrode or be adversely affected from the exposure to water, particularly chlorinated water. Such plastics, ceramics, metals, and other materials are known in the art. Alternatively, for more elegant or expensive installations, components of the waterfall device 12 can be made of more elegant or expensive materials, such as gold, silver, pewter, crystal, and the like.

In operation and use, the waterfall device 12 provides an aesthetically pleasant illuminated waterfall 46 into spa unit 10. The present invention further can be used as an alternate flowpath for filling an artificial body of water and a unit for illuminating the water feature and waterfall for enhanced aesthetics.

As noted above, the present invention is applicable to generating waterfalls for spas, swimming pools, tubs and the like and is believed to be particularly useful for illuminating such waterfalls for an aesthetically pleasing effect. The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A water feature, for use in connection with a body of water, comprising:
a) an outer tube having an axis, an at least partially hollow interior and a water inlet, and capable of being mounted proximal to the body of water with the axis in a generally vertical orientation;
b) an inner tube having an axis, an at least partially hollow interior, at least one baffle, and a water outlet, and being slidably displaceably mounted within the outer tube, the inner tube and the outer tube being generally coaxial and having generally concentric horizontal cross-sections;
c) a shaped top surface; and
d) a water flow path defined by the water inlet, the hollow interior of the outer tube, the hollow interior of the inner tube, the water outlet, and the shaped top surface,
wherein, the baffle is positioned on the inner tube and structured such that water flowing into the outer tube contacts the baffle causing the inner tube to be slidably displaced upwardly and outwardly relative to the outer tube and the water outlet is structured and positioned through the shaped top surface such that water flowing out of the water outlet flows across the shaped top surface creating a waterfall effect, and
wherein, when water ceases to flow into the outer tube, the inner tube slidably displaces downwardly and inwardly relative to the outer tube.

2. The water feature as claimed in claim 1, wherein a first stop located on the inner tube cooperates with a second stop located on the outer tube preventing the inner tube from sildably displacing completely out of the outer tube.

3. The water feature as claimed in claim 1, wherein the outer tube has an outer diameter of between about 1 inch and about 4 inches and the inner tube inner tube has a height of between about 2 inches and about 12 inches.

4. The water feature as claimed in claim 1, wherein the outer tube has an outer diameter of between about 2 inch and about 3 inches and the inner tube inner tube has a height of between about 4 inches and about 7 inches.

5. The water feature as claimed in claim 1, further comprising an illumination source and wherein:
a) at least a portion of the inner tube comprises an at least partially translucent or transparent material;
b) the illumination source cooperates with the inner tube such that light emanating from the illumination source travels into the inner tube,
whereby, the light emanating from the illumination source illuminates the inner tube.

6. The water feature as claimed in claim 1, further comprising an illumination source and wherein:
a) at least a portion of the shaped top surface comprises an at least partially translucent or transparent material;
b) the illumination source cooperates with the shaped top surface such that light emanating from the illumination source travels to the shaped top surface,
whereby, the light emanating from the illumination source illuminates the shaped top surface.

7. The water feature as claimed in claim 1, further comprising an illumination source and wherein:
a) at least a portion of the inner tube comprises an at least partially translucent or transparent material and at least a portion of the shaped top surface comprises an at least partially translucent or transparent material;
b) the illumination source cooperates with the inner tube and the shaped top surface such that light emanating from the illumination source travels into the inner tube and to the shaped top surface,
whereby, the light emanating from the illumination source illuminates the inner tube and the shaped top surface.

8. A water feature, for use in connection with a body of water, comprising:
a) an outer tube having an axis, an at least partially hollow interior, a water inlet and a diameter of between about 1 inch and about 4 inches, and capable of being mounted proximal to the body of water with the axis in a generally vertical orientation;
b) an inner tube having an axis, an at least partially hollow interior, at least one baffle, a height of between about 2 inches and about 12 inches and a water outlet, and being slidably displaceably mounted within the outer tube, the inner tube and the outer tube being generally coaxial and having generally concentric horizontal cross-sections;
c) a shaped top surface;
d) a water flow path defined by the water inlet, the hollow interior of the outer tube, the hollow interior of the inner tube, the water outlet, and the shaped top surface;
e) an illumination source,
wherein, the baffle is positioned on the inner tube and structured such than water flowing into the outer tube contacts the baffle causing the inner tube to be slidably displaced upwardly and outwardly relative to the outer tube and the water outlet is structured and positioned through the shaped top surface such that water flowing out of the water outlet flows across the shaped top surface creating a waterfall effect,
wherein, when water ceases to flow into the outer tube, the inner tube slidably displaces downwardly and inwardly relative to the outer tube, and
wherein, at least a portion of the water feature comprises an at least partially translucent or transparent material, the illumination source cooperates with the at least partially translucent or transparent material such that light emanating from the illumination source illuminates the at least partially translucent or transparent material.

9. The water feature as claimed in claim 8, wherein at least a portion of the inner tube comprises the at least partially translucent or transparent material, the illumination source cooperates with the inner tube such that the light emanating from the illumination source travels into the inner tube, whereby, the light emanating from the illumination source illuminates the inner tube.

10. The water feature as claimed in claim 8, wherein at least a portion of the shaped top surface comprises the at least partially translucent or transparent material, the illumination source cooperates with the shaped top surface such that the light emanating from the illumination source travels to the shaped top surface, whereby, the light emanating from the illumination source illuminates the shaped top surface.

11. The water feature as claimed in claim 8, wherein at least a portion of the inner tube comprises the at least partially translucent or transparent material and at least a portion of the shaped top surface comprises the at least partially translucent or transparent material, the illumination source cooperates with the inner tube and the shaped top surface such that the light emanating from the illumination source travels into the inner tube and to the shaped top surface, whereby, the light emanating from the illumination source illuminates the inner tube and the shaped top surface.

12. The water feature as claimed in claim 8, wherein the outer tube has an outer diameter of between about 2 inch and about 3 inches and the inner tube inner tube has a height of between about 4 inches and about 7 inches.

13. A structure for an artificial body of water comprising:
a) a spa unit having a generally horizontal floor, generally vertical side walls extending upwards from the floor, and at least one generally horizontal ledge extending outward from the walls; and
b) a water feature mounted on the ledge, the water feature comprising:
i) an outer tube having an axis, an at least partially hollow interior, an outer diameter of between about 1 inch and about 4 inches and a water inlet, and being mounted on the ledge with the axis in a generally vertical orientation;
ii) an inner tube having an axis, an at least partially hollow interior, at least one baffle, a height of between about 2 inches and about 12 inches and a water outlet, and being slidably displaceably mounted within the outer tube, the inner tube and the outer tube being generally coaxial and having generally concentric horizontal cross-sections;
iii) a shaped top surface; and
iv) a water flow path defined by the water inlet, the hollow interior of the outer tube, the hollow interior of the inner tube, the water outlet, and the shaped top surface,
wherein, the baffle is positioned on the inner tube and structured such than water flowing into the outer tube contacts the baffle causing the inner tube to be slidably displaced upwardly and outwardly relative to the outer tube and the water outlet is structured and positioned through the shaped top surface such that water flowing out of the water outlet flows across the shaped top surface creating a waterfall effect onto the ledge, and
wherein, when water ceases to flow into the outer tube, the inner tube slidably displaces downwardly and inwardly relative to the outer tube.

14. The water feature as claimed in claim 13, wherein a first stop located on the inner tube cooperates with a second stop located on the outer tube preventing the inner tube from sildably displacing completely out of the outer tube.

15. The water feature as claimed in claim 14, further comprising an illumination source and wherein:
a) at least a portion of the inner tube comprises an at least partially translucent or transparent material;
b) the illumination source cooperates with the inner tube such that light emanating from the illumination source travels into the inner tube,
whereby, the light emanating from the illumination source illuminates the inner tube.

16. The water feature as claimed in claim 14, further comprising an illumination source and wherein:
a) at least a portion of the shaped top surface comprises an at least partially translucent or transparent material;
b) the illumination source cooperates with the shaped top surface such that light emanating from the illumination source travels to the shaped top surface,
whereby, the light emanating from the illumination source illuminates the shaped top surface.

17. The water feature as claimed in claim 14, further comprising an illumination source and wherein:
a) at least a portion of the inner tube comprises an at least partially translucent or transparent material and at least a portion of the shaped top surface comprises an at least partially translucent or transparent material;
b) the illumination source cooperates with the inner tube and the shaped top surface such that light emanating from the illumination source travels into the inner tube and to the shaped top surface,
whereby, the light emanating from the illumination source illuminates the inner tube and the shaped top surface.

18. A structure for an artificial body of water comprising:
a) a spa unit having a generally horizontal floor, generally vertical side walls extending upwards from the floor, and at least one generally horizontal ledge extending outward from the walls; and
b) a water feature mounted on the ledge, the water feature comprising:
i) an outer tube having an axis, an at least partially hollow interior, an outer diameter of between about 1 inch and about 4 inches and a water inlet, and being mounted on the ledge with the axis in a generally vertical orientation;
ii) an inner tube having an axis, an at least partially hollow interior, at least one baffle, a height of between about 2 inches and about 12 inches and a water outlet, and being slidably displaceably mounted within the outer tube, the inner tube and the outer tube being generally coaxial and having generally concentric horizontal cross-sections;
iii) a shaped top surface;
iv) a water flow path defined by the water inlet, the hollow interior of the outer tube, the hollow interior of the inner tube, the water outlet, and the shaped top surface; and
v) an illumination source,
wherein, the baffle is positioned on the inner tube and structured such than water flowing into the outer tube contacts the baffle causing the inner tube to be slidably displaced upwardly and outwardly relative to the outer tube and the water outlet is structured and positioned through the shaped top surface such that water flowing out of the water outlet flows across the shaped top surface creating a waterfall effect onto the ledge,
wherein, when water ceases to flow into the outer tube, the inner tube slidably displaces downwardly and inwardly relative to the outer tube, and
wherein, at least a portion of the water feature comprises an at least partially translucent or transparent material, the illumination source cooperates with the at least partially translucent or transparent material such that light emanating from the illumination source illuminates the at least partially translucent or transparent material.

19. The structure as claimed in claim 18, wherein a first stop located on the inner tube cooperates with a second stop located on the outer tube preventing the inner tube from sildably displacing completely out of the outer tube.

20. The structure as claimed in claim 18, wherein at least a portion of the inner tube comprises the at least partially translucent or transparent material, the illumination source cooperates with the inner tube such that the light emanating from the illumination source travels into the inner tube, whereby, the light emanating from the illumination source illuminates the inner tube.

21. The structure as claimed in claim 18, wherein at least a portion of the shaped top surface comprises an at least partially translucent or transparent material, the illumination source cooperates with the shaped top surface such that the light emanating from the illumination source travels to the shaped top surface, whereby, the light emanating from the illumination source illuminates the shaped top surface.

22. The structure as claimed in claim 16, wherein at least a portion of the inner tube comprises an at least partially translucent or transparent material and at least a portion of the shaped top surface comprises an at least partially translucent or transparent material, the illumination source cooperates with the inner tube and the shaped top surface such that the light emanating from the illumination source travels into the inner tube and to the shaped top surface, whereby, the light emanating from the illumination source illuminates the inner tube and the shaped top surface.
